(19) United States
(12) Patent Application Publication
(10) Pub. No.: US 2014/0152508 A1
(43) Pub. Date: Jun. 5, 2014

(54) RF Confinement System

(71) Applicants: Chrstopher Peter Kirk, Witley (GB); Steve Martin Brooks, Pyrford (GB)

(72) Inventors: Chrstopher Peter Kirk, Witley (GB); Steve Martin Brooks, Pyrford (GB)

(73) Assignee: PET MATE LIMITED, Hersham (GB)

(21) Appl. No.: 14/093,436

(22) Filed: Nov. 30, 2013

(30) Foreign Application Priority Data
Nov. 30, 2012 (GB) 1221647.9

(51) Int. Cl. G01S 5/08; A01K 3/00

(52) U.S. Cl. CPC G01S 5/08; A01K 3/00
USPC 342/464

(57) ABSTRACT

A system of locating a moveable RFID transceiver, in which the moveable transceiver is capable of sending and receiving TOF (Time of fight) signals, and also includes battery powered base stations suitable for outdoor use, and capable of sending and receiving TOF signals. The system measures the signals to derive time of flight information between the moveable transceiver and the base stations and using this data to calculate the position of the moveable transceiver. The position of the base stations may be fixed using TOF signals before attempting location of the moveable RFID transceiver. The base stations may be solar powered, and can work with a base network of only 2 base stations.

This invention relates to a RF confinement system, more particularly, a method of determining a moveable object's position, and assessing whether the object crosses a boundary of a particular area.

An example is where many owners of pets would like to allow their animals to roam freely within a particular area, but not to leave that area. It may be impractical to enclose the whole area with a physical barrier that prevents the animal from leaving the area.

One common method for confining pets requires a cable is buried or laid around the perimeter of the area. The pet wears a collar with a receiver, and the collar's proximity to the cable is measured, and the pet is warned (often using a safe electric shock) not to approach or cross the perimeter. It can be inconvenient to have a cable running around the entire perimeter of an area, particular a large area, and especially if the cable is to be buried.

An alternative method uses a number of radio base stations to fix the position of the pet (wearing a transceiver collar). The base stations are usually distributed at different points in the pet owner's house, so that they may be conveniently connected to a power source. By determining the distance between the pet (i.e. the collar transceiver) and each base station, the position of the pet may be determined by trilateration.

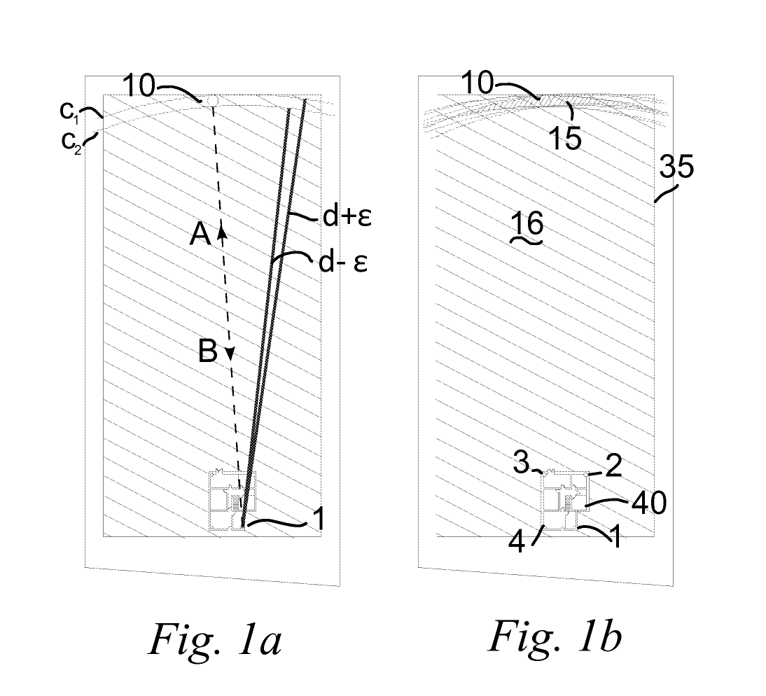

This system is shown in FIG. 1a. A first Base Station 1 sends out a message (A) and records the time message (A) was sent. The collar transceiver PET 10 receives the message (A) and sends the message (B) back, normally with a delay before the message is re-sent. This time (C) must be known. Base Station 1 then receives the message and records the time (B). The Time of flight (TOF), the time the message has taken to go from ‘Base Station 1’ to the ‘Pet 1’ and back to ‘Base Station 1’ is therefore Time (B)-Time (A)-Time (C). As radio signals travel at the speed of light, the distance between ‘Base Station 1’ and ‘Pet 1’ is half the Time of fight multiplied by the speed of light. Such a system forms the basis of electronic fences such as those described in US patent application US2011298615 (Woodstream Inc) and U.S. Pat. No. 7,259,718 (Rocket City Technology)

For simplicity, the following description will refer to the distance being measured using recorded time periods, it is to be understood that this time to distance conversion is carried out using the known speed of the radio waves in all cases.

This process is then repeated by all the other ‘Base Stations’ to get a distance from the collar transceiver Pet 1 to each base station. The position of the ‘Base Stations’ is determined when the system was set up. Therefore the positions of the Pets position can then be trialaterated.

A number of factors will affect the accuracy of the location determination. Some errors will be constant (systematic) errors such as timing errors which can easily be corrected. There will also be random errors in the times recorded due to the difficulty of identifying the exact time of the RF signal, since the clock period of the time measuring circuits may be relatively large. These inaccuracies can normally be corrected by averaging/filtering the data, by taking a sufficient number of readings.

Referring again to FIG. 1a, there will therefore be inaccuracy in finding each distance d±a tolerance ε, each base station generating two circles c₁, c₂ between which the collar transceiver may be located. So rather than being able to accurately calculate a point position, the collar receiver can be located within a possible annular area between c₁ and c₂.

Even a small error in the measured time equates to a large error in distance, since the signal is travelling at the speed of light. Also if the distance between the base stations is relatively small, inaccuracies result in a large possible location area that the pet may be located in.

The biggest problem is the signal may be reflected so that the signal has not travelled the shortest path between the base stations and the collar transceiver. This reflection error is hard to identify because if the pet is stationary the error will be constant. There are a number of techniques used to address these inaccuracies. Although only three base stations are necessary to produce a single possible location area, a fourth base station is typically used to provide a fourth distance measurement and decrease the size of the possible location area, and particularly if one of the distance measurements is being affected by reflection problems this measurement can be eliminated. Referring to FIG. 1b, the distance between four base stations 1, 2, 3, 4 and the collar transceiver 10 are measured, which generates four annuli (each having an inner and outer diameters determined by the accuracy of that particular distance measurement) in the same manner as the distance measured by base station 1 in FIG. 1a. These annuli should (subject to some further difficulties discussed below) have an overlapping region 15, providing an area in with the collar transceiver 10 must be located.

This system can have a HOME station 40, which controls the operation of the system, providing an interface to set up or change the system, turn the system on and off, and possibly provide an output indicating the location of the collar transceiver PET 25.

In addition to such these sources of inaccuracy, there are other problems which, while not leading to inaccuracy, may require that more transmissions are made, or that more power is used to make the transmissions. In particular, there may be other sources of radio frequency signals within the house, which will interfere with the base stations' signals. Also, the signal will be attenuated by solid objects.

To confine the pet in such a system, a permitted area 16 is stored by the system. When the area 15, in which the collar transceiver 10 is located, crosses the perimeter 35 of the permitted area 16, a signal is sent deterring the pet from remaining in non-permitted area. Similarly, a warning signal may be transmitted to the pet as the area 15 approaches the perimeter 35. However, it will be seen that if the system cannot locate the pet accurately, and the area 15 not sufficiently contained, the effectiveness of the system is compromised, as the pet is either permitted to cross the desired confinement perimeter, or incorrectly warned when it is not close to this perimeter.

The current demands of such as system are relatively high, due to having to take multiple readings to generate a single position area, and having to produce a signals strong enough to transmit to and detect the collar transceiver though several walls of a house. The number of message signals sent may also have to be increased if other radio frequency devices in the house are interfering with the system's signals.

It is an object of the present invention to alleviate the above problems and provide a more convenient system of electronic confinement.

In accordance with a first aspect of the present invention, there is provided an invention as recited in claim 1.

‘TOF signal’ is used in this context to mean any signal or message from which a time of flight can be calculated; the TOF signal may include data relating to a TOF calculation for that TOF signal or a previous TOF signal, such as a time signal or measured time period.

The invention allows for better positioning of the Base Stations, that is, as far apart as possible and outdoors. To make such a system practical, the power consumption must be so low that the Base Stations can operate using battery/solar power rather than being connected to mains-based power.

The invention will now be described, by way of example, with reference to the drawings, of which

FIGS. 1a and 1b show a diagrammatic representation of a prior art system;

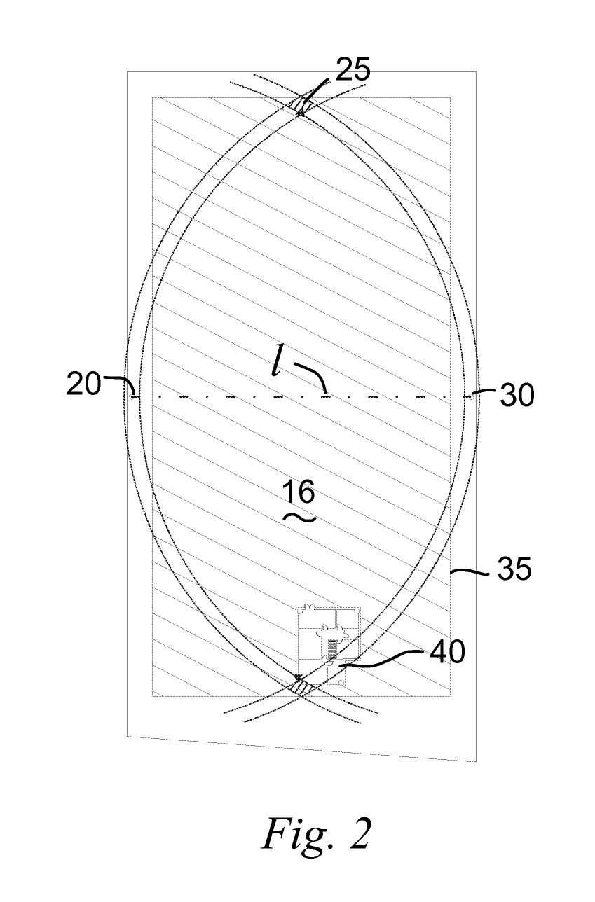

FIG. 2 shows a diagrammatic representation of an embodiment of the confinement system;

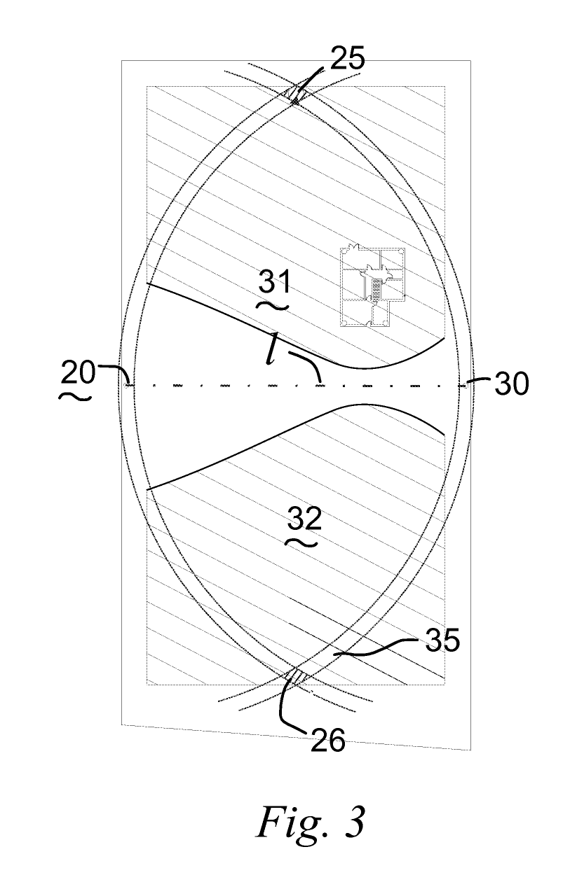

FIG. 3 shows a diagrammatic representation of another embodiment of the confinement system;

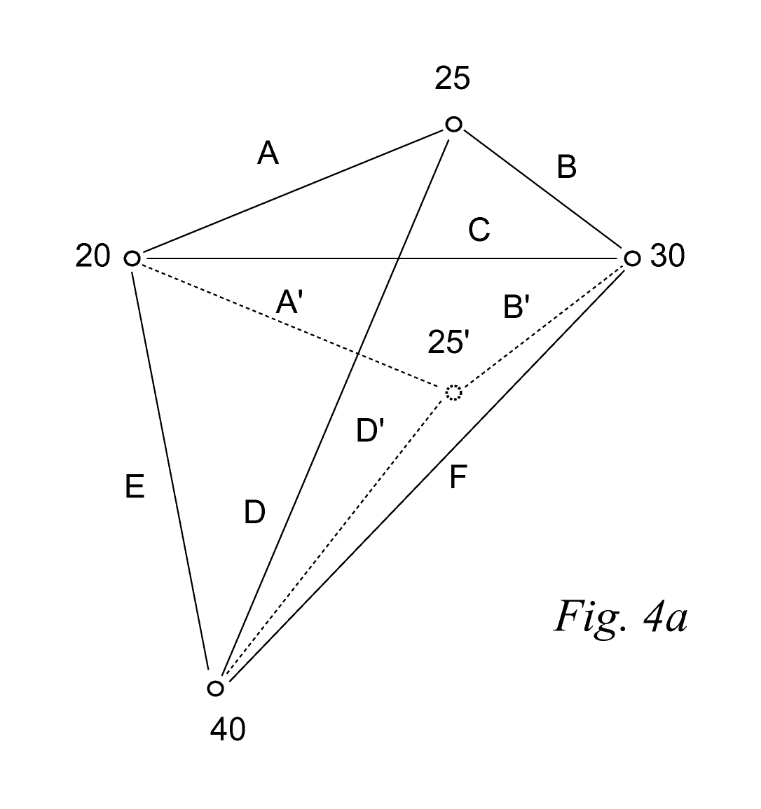

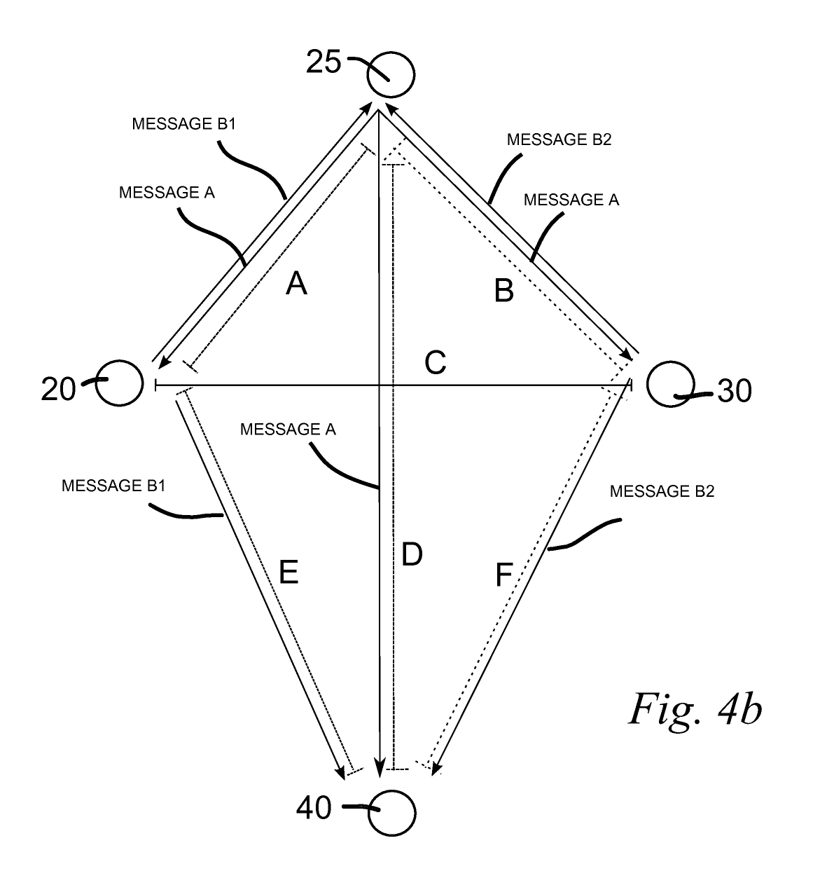

FIGS. 4a and 4b show diagrammatic representations of a further embodiment of the confinement system;

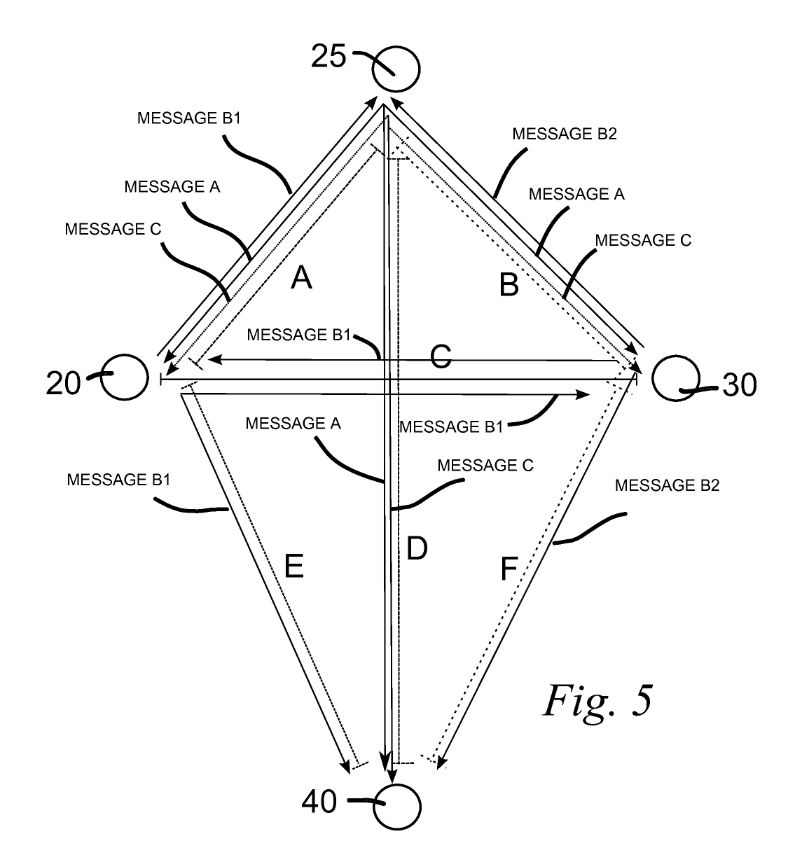

FIG. 5 shows a diagrammatic representation of a further embodiment of the confinement system.

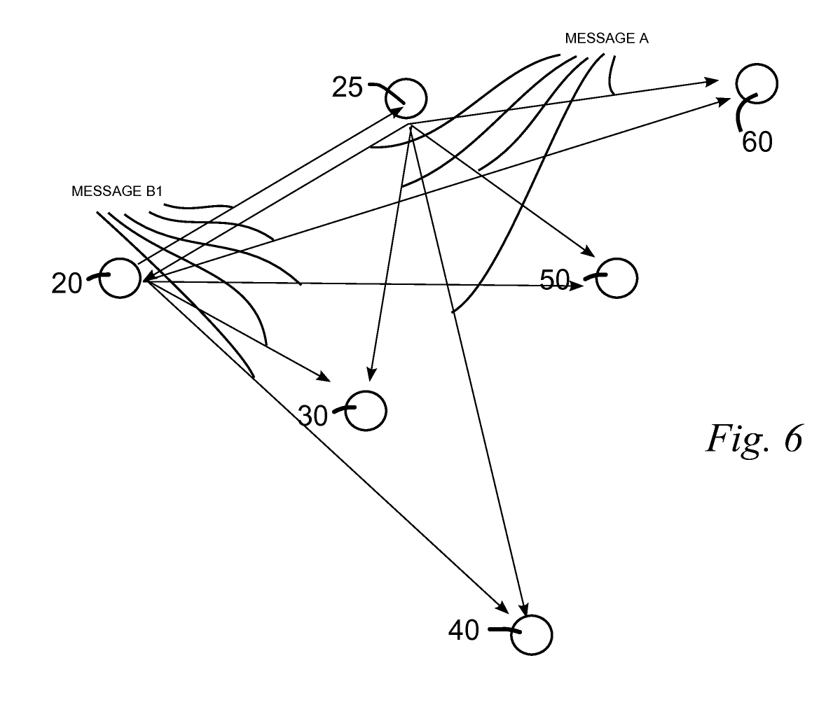

FIG. 6 shows a diagrammatic representation of a further embodiment of the confinement system.

### EMBODIMENT 1A

Referring to FIG. 2, a pet confinement system comprises a first BASE 1 station 20, a BASE 2 station 30 and a collar transceiver PET 25 that is worn by the pet.

The area 16 in which the pet is to be confined must be chosen to include a centreline l about which the area has reflective symmetry. For example, the area may be square or rectangular, though it will be seen that many other shapes (including shapes having curved edges) are possible as long as the shape is symmetrical. BASE 1 station 20 and BASE 2 station 30 are positioned outside the house, on the centreline l, spaced as far apart as possible, which will usually be at the two points where the centreline l intersects the perimeter of the confinement area 16 (BASE 1 station 20 and BASE 2 station 30 may even be located outside the perimeter of the confinement area).

This system can have a HOME station 40, which controls the operation of the system, providing an interface to set up or change the system, turn the system on and off, and possibly provide an output indicating the location of the collar transceiver PET 25. The Home station can also carry out the data processing and computation of the collar transceiver location. The home station will be situated by the user in the user's house, and can be powered by mains electricity. However, it will however be appreciated that input, control and processing functions here attributed to the HOME station 40 may instead be incorporated into one or both of the outside, battery-powered BASE stations, 20, 30.

When the system is initially set up, it may be programmed in a similar way to conventional systems, albeit that the permitted area for the PET 25 has reflective symmetry. As for conventional systems, excluded areas (for examples, a pond or flower beds) may be included within the permitted area, however such areas must also possess reflective symmetry about the centreline l.

In order to ascertain the position of the collar transceiver, the first BASE 1 station 20 sends a message (A) and records the time message (A) was sent. The collar transceiver PET 25 receives the message (A), processes the message and prepares to respond to message (A), this processing delay (C) being known. The collar transceiver PET 25 then sends the response message (B), which is received by BASE 1 station 20 which records the time (B).

The time of flight, that is, the time the message has taken to go from BASE 1 station 20 to the collar transceiver PET 25 and back again is therefore Time (B)-Time (A)-Time (C). The distance between the BASE 1 station 20 to the collar transceiver PET 25 is therefore half the Time of fight multiplied by the speed of light.

This process is then repeated by BASE 2 station 30, BASE 2 station 30 sending a message to collar transceiver PET 25 which sends a response message back to BASE 2 station 30, the time of flight recorded the distance from the collar transceiver PET 25 to BASE 2 station 30 being calculated in the same manner.

The position of BASE 1 station 20 and BASE 2 station 30 are determined during the setting up of the system (the distance separating the two stations may be conveniently determined by one base stations sending the other a message and timing the response, compensating for the response delay in a similar manner to the determination of distance between a base station and the collar transceiver. The position of the collar transceiver PET 25 (and so the position of the PET 25) relative to the permitted area may then be determined.

The pet could be confined to a non-symmetric area by placing the base stations and the whole centreline completely outside, and spaced from, the permitted area. Referring to FIG. 3, an area 31 is delimited above the centreline l, in which the pet 25 is confined. A similar area 32, reflected in the centreline, will exist, but provided the pet does not at any time leave the permitted area 31 and cross the centreline, a single location area 25 for the pet collar transceiver can be determined and a second apparent area 26 can be discounted.

### EMBODIMENT 1B

Referring to FIG. 4a, in an alternative embodiment, as for the previous embodiment, BASE 1 station 20 and BASE 2 station 30 are located outside the house and widely spaced, and a HOME station 40 is located in the house; in this embodiment (and the next) the HOME station 40 is required for the full operation of the system. The HOME station 40 is equipped to receive the messages sent by BASE 1 station 20, BASE 2 station 30 and collar transceiver PET 25.

In this embodiment, referring to FIG. 4b, collar transceiver PET 25 sends message A to BASE 1 station 20 and to BASE 2 station 30. On receiving message A, BASE 1 station 20 responds with message B1, and BASE 2 station 30 responds with message B2. From these responses, collar transceiver PET 25 can measure the TOFs corresponding to distances A and B respectively, and so distances A and B can be ascertained. (The distances A to F in FIG. 4b are to be understood as extending fully to each station or the pet transceiver, but have been shown slightly shortened for clarity)

Distance C in FIG. 4b is known, for example from during the set up. Distance E & F can be ascertained also during the setup, but as the HOME station can be moved after setup it will need verifying regularly. As for the previous embodiment, the determination of distance A and B give two locations (or possible areas of location), above and below the centre line—collar transceiver PET 25 and collar transceiver PET 25′.

HOME station 40 also receives message A from collar transceiver PET 25, followed by the responses from BASE 1 station 20 and BASE 2 station 30, messages B1 and B2 respectively. HOME station 40 can therefore directly measure distance A+distance E−distance D from message A and message B1.

Referring back to FIG. 4a, this value will be greater for collar transceiver PET 25′ than for collar transceiver PET 25 (since distance A′ is the same as distance A, and distance D′ is less than distance D). Distance D can therefore be determined, to give a single possible area of location of collar transceiver PET 25. It should be noted that for this to be valid, HOME station 40 must remain on one side of the line C, but since HOME station 40 is located in the house, in practice this will always be the case.

Similarly, message B2 from BASE 2 station 30 allows the HOME station 40 to measure a TOF corresponding to distance B+distance F−distance D.

This gives an additional constraint that can be used to more accurately determine the location of collar transceiver PET 25.

These two additional values measured by HOME station 40 allow any spurious result given by a reflected signal to be more easily identified and rejected. But this can be improved in Embodiment 1C below.

As for the previous embodiment, a permitted area may be programmed into the system in a conventional manner, the permitted area may be non-symmetrical. Asymmetric excluded areas may be included within the permitted area.

The sending of message A and message B could alternateively be initiated by BASE 1 station 20 and BASE 2 station 30 as for embodiment 1A; however, it will be seen that by having the collar transceiver PET 25 initiating the transmittal of messages, fewer transmissions are required.

Also, at least some of the messages can advantageously include one or more previously recorded time of flights, so that separate information transmission do not have to be made. The sequence described above will typically be repeated several times a second (particularly when the pet is moving). Message A can conveniently include the TOF across distances A and B from the previous sequence. The HOME station 40 can use these measurements in its calculation. It will be seen that the TOFs included in message A belong to the previous sequence of measurements, and may be used in conjunction with the TOFs previously directly measured by HOME station 40 (over distances (A+E−D) and (B+F−D)). However, the position of the collar transceiver PET 25 does not greatly change from one reading to the next, so little inaccuracy results from using the TOFs included in message A with those directly measured by collar transceiver PET 25 in the same sequence.

This can also be done in a less efficient way by the home station 40 and Pet 25 sending a pair or more of messages to find TOF.

### EMBODIMENT 1C

### All Devices Listening

Referring to FIG. 5, in a further embodiment, the previous embodiment described and illustrated in FIGS. 4a and 4b may be further refined. Again, BASE 1 station 20 and BASE 2 station 30 are located outside the house and widely spaced, and HOME station 40 is located in the house.

In this system a reduced sequence of messages are sent to give the minimal power requirement and RF traffic. If the messages used to ascertain the TOF/distance also include the value corresponding to the distance calculated from the last set of messages, this saves sending separate massages at the end of a sequence.

In this system, each BASE 1 station 20, BASE 2 station 30, HOME station 40 and collar transceiver PET 25 listen to each message transmitted by the other units. A convenient sequence would be:

a) Collar transceiver PET 25 sends message A which is received by BASE 1 station 20, BASE 2 station 30 and HOME station 40.
b) When BASE 1 station 20 receives message A, it responds with message B1.
c) When BASE 2 station 30 receives message A, it responds with message B2.
d) Message B1 from station 20 is received by BASE 2 station 30, collar transceiver PET 25 and HOME station 40, and message B2 from station 30 is received by BASE 1 station 20, collar transceiver PET 25 and HOME station 40.
e) When collar transceiver PET 25 has received messages B1 and B2, it responds with message C (which is again received by BASE 1 station 20, BASE 2 station 30 and HOME station 40).

From these four message transmissions, values for the following distances are collected;

Distance A is measured 4 times
Distance B is measured 4 times
Distance B+C−A is measured
Distance A+C−B is measured
Distance A+E−D is measured
Distance B+F−D is measured

These additional constraints provide increased accuracy, by allowing more averaging to be performed.

In this embodiment therefore 4 messages generate 12 distances. In prior art U.S. Pat. No. 7,259,718, 8 messages are needed to generate 3 distances. The method described herein is 800% more efficient than this prior art system.

There are several inter-related advantages of the embodiments described herein, some of which rely on each other, and make other advantages possible.

Because distance A and B are measured using timings from Base 1, Base 2, Pet and Home Station, these can be compared and reflection can be seen and removed from the calculations or the value of the refection can be calculated and corrected for. This removes the need for additional base stations to remove reflection from the calculations which reduces system cost and power requirements/RF traffic. There are several known ways of treating spurious results and removing inaccuracies, including combinations of averaging techniques and excluding outliers.

The wide spacing outside a house of the base stations is made practical by implementation of a power efficient transmission procedure, so that it becomes feasible to power the base stations using batteries (ideally with augmentation with solar power)

The outside placement also reduces problems of attenuation and reflection by building structures. Interference with other home-based RF devices is avoided. This reduces the need for re-transmission of signals, reducing the power requirements.

In the second and third embodiments, accuracy is increased without unduly increasing power consumption, particularly in the outside base stations, by the more efficient utilisation of transmitted signals.

Another important aspect of the systems is that fewer base stations are required. In the prior art system, three or four transmitting stations are required, in addition to a control station and a collar transceiver. In the embodiments disclosed herein, accuracy is achieved using two transmitting stations, and optionally a control stations, in addition to the pet transceiver. This represents a significant cost saving.

As well as enabling an accurate system using two base stations (with or without a control station), the same system can be extended to use more than two base stations, but achieving a higher degree of accuracy than achieved by prior art systems using the same number of stations. Alternatively, three or more base stations can be used to achieve the same level of accuracy as a prior art system using that number of stations, while using less accurate (and therefore cheaper) individual stations.

Referring to FIG. 6, there is shown an array of base stations 20, 30, 50, 60, a control station 40, and a pet collar transceiver 25. Pet collar transceiver starts the process by broadcasting a signal message A, which is received by all the base stations 20, 30, 50, 60, and the control station 40. When base station 20 receives message A, it broadcasts a signal message B1, which is received by the other base stations 30, 50, 60, and the control station 40 and the pet collar transceiver 25. The other base stations 30, 50 and 60 will send similar signal messages upon receipt of message A, and these signal messages will be received by the other base stations, the pet collar transceiver 25, and the control station 40. Finally, pet transceiver 25 will send a message C. In this embodiment, the control station 40 does not itself transmit a message to be used in a TOF calculation, though this could also be done with the control station receiving and transmitting such messages in the same manner as the other base stations.

In this arrangement, the number of separate distance readings taken will be 30 in total; in general the total number of readings per sequence for n control stations will be (n+1)(n+2) (where n does not include the pet transceiver or the control station).

1. A system of locating a moveable RFID transceiver, comprising;
a moveable transceiver capable of sending and receiving TOF (Time of fight) signals
battery powered base stations suitable for outdoor use, and capable of sending and receiving TOF signals
the system being capable of measuring the signals to derive time of flight information between the moveable transceiver and the base stations and using this data to calculate the position of the moveable transceiver.

2. A system according to claim 1, wherein the position of the base stations is fixed using TOF signals before attempting location of the moveable RFID transceiver.

3. A system according to claim 1 wherein the base stations are solar powered

4. A system according to claim 1 wherein the base network of only 2 base stations.

5. A system according to claim 1 wherein there is included a home station capable of controlling the system, and receiving the TOF signals, allowing the location of the moveable transceiver to be ascertained within a non-symmetrical shape.

6. A system according to claim 1 wherein there is included a home station receiving and sending TOF signals, allowing the location of the moveable transceiver to be ascertained within a non-symmetrical shape.

7. A system according to claim 1 wherein all devices are capable of receiving each TOF signal so as to calculate additional distances to reduce power requirements and/or RF traffic and detect reflections.

8. A system according to claim 1 wherein the first TOF signal is sent from the moveable transceiver
a second TOF signal is sent from the first base station in response to first TOF signal, and received by the moveable transceiver, to generate one direct measurements of distance and/or a further two or more indirect measurements.
a third TOF signal is sent from second base station in response to first TOF signal, and received by the moveable transceiver, to generate a further one direct measurements of distance and/or a further two or more indirect measurements.

9. A system according to claim 8 wherein a fourth TOF signal is sent from the moveable transceiver in response to second and third TOF signals to give a further two direct measurements of distance and/or a further four or more indirect measurements

10. A system according to claim 1 wherein the TOF signal includes data relating to the measurement a previous time of flight of a TOF signal.
